(19) United States
(12) Patent Application Publication
(10) Pub. No.: US 2023/0264307 A1
(43) Pub. Date: Aug. 24, 2023

(54) TOOL POT

(71) Applicant: OKUMA CORPORATION, Niwa-gun (JP)

(72) Inventor: Makoto Yoshida, Niwa-gun (JP)

(73) Assignee: OKUMA CORPORATION, Niwa-gun (JP)

(21) Appl. No.: 18/171,465

(22) Filed: Feb. 20, 2023

(30) Foreign Application Priority Data
Feb. 21, 2022 (JP) 2022-024365

(51) Int. Cl. B23Q 3/155

(52) U.S. Cl. CPC B23Q 3/15526; B23Q 2003/15532

(57) ABSTRACT

Provided is a tool pot overcoming a problem that dirt adhered to the tool pot is transferred to a contact face of a tool. A tool pot includes an inner-periphery holding part that holds an inner periphery of a tapered shank and prevents axial movement of a tool, an end-face holding part that prevents rotation of the tool, which is implemented by a key fitted into a keyway provided at an end surface of the tapered shank, and an outer-periphery holding part that is opposed to an outer periphery of the V-flange and prevents radial movement of tool. The inner-periphery holding part, the end-face holding part, and the outer-periphery holding part hold the tool in a state where there are clearances with respect to an outer peripheral surface of the tapered shank and an end face of the V-flange, respectively.

### DETAILED DESCRIPTION OF THE PRESENT INVENTION

### Technical Field

The present invention relates to a tool pot that holds a tool in a machine tool such as a machining center having an automatic tool changing function.

### Background Art

In this description, the term “tool” means a tool as a single component in some cases, and also means a combination of a tool as a single component and a tool holder to which the tool is attached in other cases.

For example, in automatic tool changers of machining centers, as a tool pot used in a ready station for transferring a tool between a tool magazine and a tool changing arm, or as a tool pot used in a tool magazine, a conventionally known tool pot is configured to accommodate a tool in a hole having a tapered shape that is in conformity with a tapered shape of a tapered shank of the tool, and to bring these tapered faces of the tool pot and the tool in close contact with each other thereby holding the tool.

There are several types of tools depending on the shape of its shank, which include a BT type, an HSK type, and the like. Patent Literature 1 discloses an HSK-type tool (a tool of a two-surface-constraining type, having a V-flange provided with a V-groove, and a tapered shank having a hollow shape and continued to the V-flange) and a tool pot therefor.

### CITATION LIST

### Patent Literature

Patent Literature 1: Japanese Unexamined Patent Application Publication No. 2010-167514

### SUMMARY OF THE INVENTION

### Problem to be Solved by the Invention

According to the tool pot of Patent Literature 1, since an outer peripheral tapered surface of the tapered shank and an end face of the V-flange of the HSK-type tool is configured to contact the tool pot, there was a problem that dirt adhered to the tool pot was transferred to a contact face of the tool, which could cause machining failures when the tool was mounted to a main shaft of the machine tool.

The present invention is directed to a tool pot to be used for a tool of the two-surface-constraining type, which is referred to as an HSK type, and an object of the present invention is to provide a tool pot that has overcome the problem that dirt adhered to the tool pot is transferred to the contact face of the tool.

### Means for Solving the Problem

The tool pot according to the present invention is a tool pot configured to hold a tool including a V-flange provided with a V-groove, and a tapered shank continued to the V-flange and having a hollow shape, the tool pot including: an inner-periphery holding part configured to hold an inner periphery of the tapered shank and prevent axial movement of the tool; an end-face holding part configured to prevent rotation of the tool, which is implemented by a key that is fitted into a keyway provided at an anti-V-flange-side end surface of the tapered shank; and an outer-periphery holding part that is opposed to an outer periphery of the V-flange and is configured to prevent radial movement of the tool, wherein the inner-periphery holding part, the end-face holding part, and the outer-periphery holding part hold the tool in a state where there are clearances with respect to an outer peripheral tapered surface of the tapered shank and an end face of the V-flange, respectively.

With the tool pot of the present invention, when the tool pot is caused to move to a position where the tool pot holds the tool, the inner-periphery holding part holds the inner periphery of the tapered shank whereby axial movement of the tool is prevented, the key of the end-face holding part is fitted into the keyway provided at the anti-V-flange-side end surface of the tapered shank of the tool whereby rotation of the tool is prevented, and the outer-periphery holding part is opposed to the outer periphery of the V-flange whereby radial movement of the tool is prevented. This allows the tool to be reliably held by the tool pot. In addition, at the time when the tool is held, a situation is provided in which there are clearances with respect to the outer peripheral tapered surface of the tapered shank and the end face of the V-flange of the tool, respectively, whereby it is possible to overcome the problem that dirt adhered to the tool pot is transferred to the contact surface of the tool.

It is preferable that the inner-periphery holding part has: a holder having a cylindrical peripheral wall positioned radially inward of the tapered shank; a plurality of steel balls respectively disposed in a plurality of through holes in a radially movable manner, the through holes each being provided at a part, opposed to the tapered shank, of the peripheral wall of the holder; and a pressing member configured to press the plurality of steel balls radially outward, and the plurality of steel balls pressed by the pressing member move radially outward to press a tapered face provided on the inner periphery of the tapered shank in an axial direction of the tool, and a flange part provided on the peripheral wall of the holder receives the end surface of the tapered shank, whereby axial movement of the tool is prevented.

With this configuration, by causing the pressing member to move to an advance position (in a direction nearing the tool), the plurality of steel balls move radially (in a direction orthogonal to the axis of the tool) outward, and press the tapered face provided at the inner periphery of the tapered shank in the axial direction of the tool, so that the end surface of the tapered shank is received by the flange part provided on the peripheral wall of the holder, whereby movement in the axial direction of the tool is prevented. The prevention of the axial movement of the tool does not require holding the tapered shank and the V-flange of the tool by means of surface contact, which facilitates the holding of the tool in a state where there are clearances with respect to the outer peripheral tapered surface of the tapered shank and the end face of the V-flange.

It is preferable that the pressing member has a shaft shape and has a distal end portion provided at an outer periphery thereof with a tapered face, and is disposed in a cylinder chamber so as to move in an axial direction of the pressing member upon supply of compressed air, and movement of the distal end portion of the pressing member in a distal end direction thereof causes the tapered face to move the plurality of steel balls radially outward.

With this configuration, it is possible, by switching supply of compressed air to the cylinder chamber to cause the pressing member to move axially, to readily obtain a state where the tool is held with the pressing member being in the distal end direction, and the plurality of steel balls being radially outward, and a state where the tool is not held with the pressing member being in a direction opposite to the distal end, and the plurality of steel balls being radially inward, which allows the holding operation of the tool onto the tool pot to be performed simply.

It is preferable that the outer-periphery holding part is configured by a plurality of pins that are opposed to an outer peripheral surface of the V-flange.

With this configuration, the outer-periphery holding part prevents the V-flange from moving radially outward in a state where the tool is being held, and also enables the guide operation to be performed at the time when the tool is to be held in the tool pot, whereby the V-flange is reliably held.

### Advantageous Effects of the Invention

The tool pot of the present invention is capable of overcoming the problem that dirt adhered to the tool pot is transferred to a contact face of the tool.

### BRIEF DESCRIPTION OF THE DRAWINGS

FIG. 1 is a vertical cross-sectional view showing a tool pot according to an embodiment of the present invention, which shows a state before a tool is held.

FIG. 2 is a vertical cross-sectional view showing the tool pot, which shows a state where the tool is being held.

FIG. 3 is an enlarged vertical cross-sectional view, which shows states before and after the tool is held.

### DESCRIPTION OF EMBODIMENTS

The embodiment of the present invention will be described below, with reference to the drawings. In the following description, the upper and lower sides of each drawing will be referred to as “upper” and “lower”, respectively. Although the upward/downward (axial) movement of a tool pot (11) relative to a tool (1) is relative movement, the following description will be given on the assumption that the tool (1) moves upward/downward.

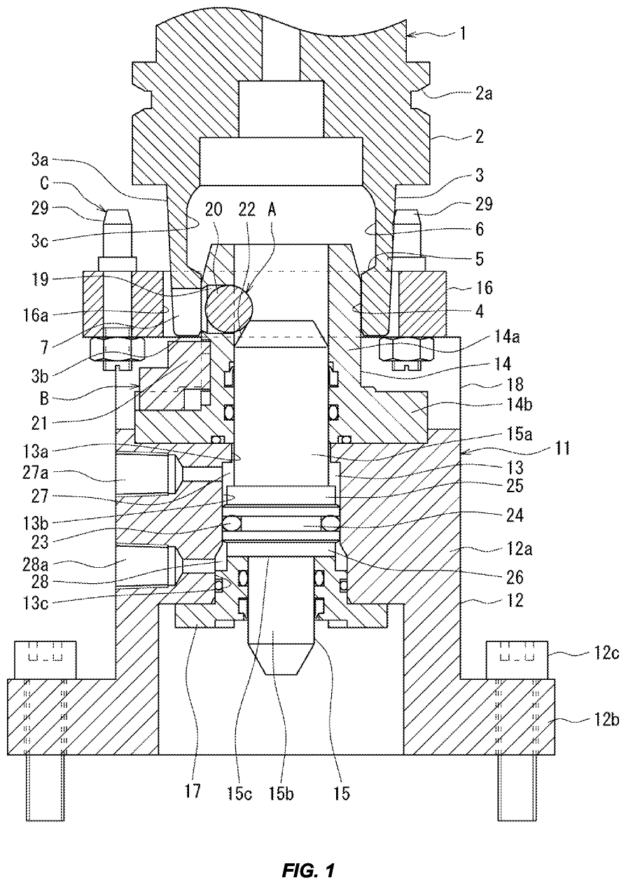

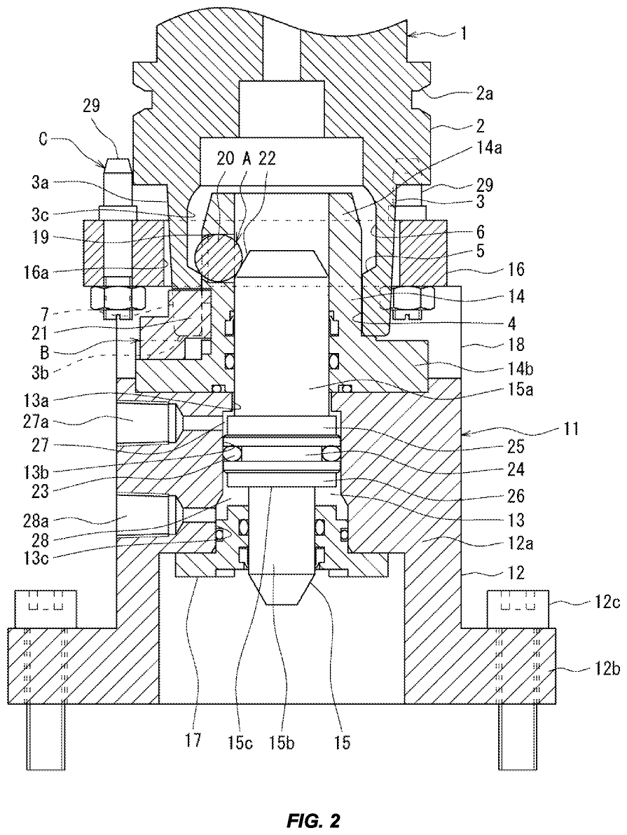

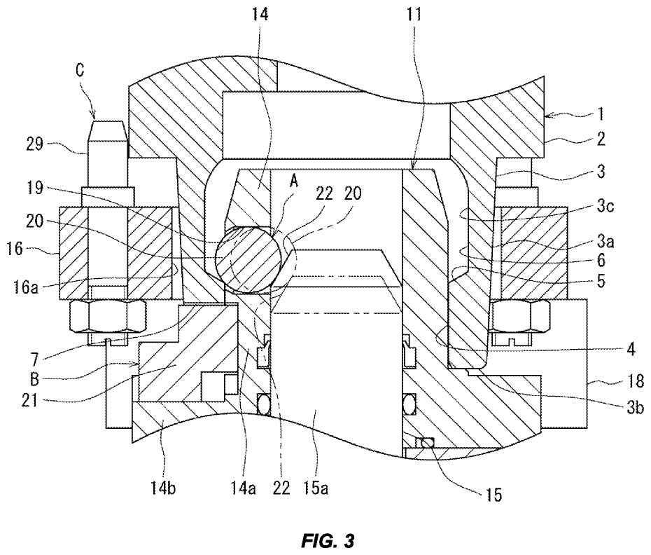

FIG. 1 shows a state where the tool (1) is in the middle of downward movement (a state before the tool (1) is held by the tool pot (11)). FIG. 2 shows a state where the tool (1) moves to the lowest position and the tool (1) is being held by the tool pot (11). FIG. 3 aims to compare the states before and after the tool (1) is held, and shows a state where a rod (15) as a pressing member is positioned upward and the tool (1) is being held by the tool pot (11), which is indicated by solid lines, and shows a state where the rod (15) is positioned downward, which is indicated by alternate long and two short dashes lines.

The tool pot (11) is used, for example, in an automatic tool changer of a machining center when the tool (1) is received and delivered between a tool magazine and a tool changing arm.

The tool pot (11) in this embodiment is used for the tool (1) having a hollow tapered shank of a two-surface-constraining type, which is referred to as an HSK type. The tool (1) has a V-flange (2) provided with an annular V-groove (2a) that has a V-shaped cross section,

and a tapered shank (3) to which the V-flange (2) is continued downward and which has a hollow shape.

The tapered shank (3) has an outer peripheral surface (3a) that is a tapered surface having a smaller diameter toward a lower end thereof, a lower end surface (3b) that is perpendicular to the axis of the tapered surface, and an inner peripheral surface (3c). The inner peripheral surface (3c) includes a lower cylindrical face (4) that extends upward from the lower end surface (3b) and is perpendicular to the lower end surface (3b), a tapered face (5) that extends upward from an upper end of the lower cylindrical face (4) so as to have a larger diameter toward the upward direction, and an upper cylindrical face (6) that extends upward from an upper end of the tapered face (5).

The outer diameter of the tapered shank (3) on a large-diameter side thereof is made smaller than the outer diameter of the V-flange (2). The lower end surface (3b) of the tapered shank (3) is provided at one location (at least one location) on a circumference thereof with a keyway (7).

The tool pot (11) includes: a base member (12) positioned on a lower end side thereof (on a side that is the farthest from the tool (1)); a cylinder chamber (13) provided at the base member (12); a cylindrical holder (14) fixed on an upper surface of the base member (12); a cylindrical rod (15) disposed in a vertically movable manner both in the cylinder chamber (13) and in the holder (14); an opposed member (16) opposed to the base member (12) and positioned on an upper end side thereof (on a side receiving the V-flange (2) of the tool (1)); a guide (17) disposed at a lower end part of the cylinder chamber (13) and configured to guide a lower part (15b) of the rod (15); and a connecting member (18) configured to connect the base member (12) and the opposed member (16).

The base member (12) is composed of a rectangular parallelepiped body (12a) and a flange part (12b) which is provided at a lower end part of the body (12a) and through which bolts (12c) are inserted.

The cylinder chamber (13) is provided so as to penetrate vertically through the body (12a) of the base member (12) and is composed of a small-diameter part (13a) positioned at an upper end part thereof and having the smallest diameter, an intermediate-diameter part (13b) continued to a lower side of the small-diameter part (13a), and a large-diameter part (13c) continued to a lower side of the intermediate-diameter part (13b).

The holder (14) is composed of a peripheral wall (14a) having a cylindrical shape and a flange part (14b) provided at a lower end part of the peripheral wall (14a).

The peripheral wall (14a) is dimensioned to have an outer diameter that allows the peripheral wall (14a) to be in sliding contact with the lower cylindrical face (4) of the inner peripheral surface (3c) of the tapered shank (3).

The peripheral wall (14a) is provided at circumferentially appropriate intervals (for example, at equal intervals) thereof with a plurality of (three in this embodiment) radially through holes (19), and through the radially through holes (19), respective steel balls (20) are inserted in a radially movable manner.

On an upper surface of the flange part (14b), a key (21) to be fitted into the keyway (7) is fixed.

The rod (15) is composed of an upper part (15a) that is guided by an inner peripheral surface of the peripheral wall (14a) of the holder (14) and the small-diameter part (13a) of the cylinder chamber (13), a lower part (15b) that has a diameter smaller than that of the upper part (15a) and is guided by guide (17), and an intermediate part (15c) that is disposed between the upper part (15a) and the lower part (15b) and is guided by the intermediate-diameter part (13b) of the cylinder chamber (13).

The upper part (15a) of the rod (15) has an upper end portion. At the upper end portion, a tapered face (22) having a smaller diameter toward an upper end face side thereof is formed.

The intermediate part (15c) of the rod (15) is composed of a large-diameter portion (24) in which an O-ring (23) fitted into an O-ring groove formed at a center of the large-diameter portion (24) makes sliding contact with the intermediate-diameter part (13b) of the cylinder chamber (13), and upper and lower small-diameter portions (25), (26) provided, respectively, on both upper and lower sides of the large-diameter portion (24) and each having a diameter smaller than that of the large-diameter portion (24).

The upper small-diameter portion (25) of the intermediate part (15c) has a diameter larger than that of the upper part (15a) of the rod (15), whereby, between: a lower end part of the upper part (15a) of the rod (15) and the upper small-diameter portion (25) of the intermediate part (15c) of the rod (15); and the intermediate-diameter part (13b) of the cylinder chamber (13), a space serving as an upper air-introduction compartment (27) is formed. Likewise, the lower small-diameter portion (26) of the intermediate part (15c) has a diameter larger than that of the lower part (15b) of the rod (15), whereby, between: an upper end part of the lower part (15b) of the rod (15) and the lower small-diameter portion (26) of the intermediate part (15c); and the intermediate-diameter part (13b) of the cylinder chamber (13), a space serving as a lower air-introduction compartment (28) is formed.

With the upper and lower air-introduction compartments (27), (28), upper and lower air-introduction passages (27a), (28a) communicate, respectively. To each of the upper and lower air-introduction passages (27a), (28a), air introduction piping for supplying compressed air is connected. Compressed air having been introduced into the upper air-introduction compartment (27) presses the intermediate part (15c) (an upper face of the upper small-diameter portion (25) and an upper face of the large-diameter portion (24)) of the rod (15) downward. In addition, compressed air having been introduced into the lower air-introduction compartment (28) presses the intermediate part (15c) (a lower face of the lower small-diameter portion (26) and a lower face of the large-diameter portion (24)) of the rod (15) upward. Therefore, by switching supply of compressed air to the air-introduction compartments (27), (28), the rod (15) is allowed to move upward or downward. FIG. 1 shows a state where the rod (15) moves downward, while FIG. 2 shows a state where the rod (15) moves upward.

The tapered face (22) of the upper end portion of the rod (15) and the radially through holes (19) at the peripheral wall (14a) of the holder (14) are formed so as to move the three steel balls (20) radially outward when the rod (15) moves upward, whereby each steel ball (20) is allowed to ride up on the tapered face (5) of the inner peripheral surface (3c) of the tapered shank (3). With this configuration, the rod (15) is caused to move upward, which causes pressing of the tapered faces (5), (22) against each other with the steel balls (20) interposed therebetween, thereby allowing the tool (1) to move downward (in a direction in which the lower end surface (3b) of the tapered shank (3) is received on the upper surface of the flange part (14b) of the holder (14)). FIG. 1 shows a state where the rod (15) moves downward and each of the steel balls (20) does not press the tapered face (5) downward, while FIG. 2 shows a state where the rod (15) moves upward and each of the steel balls (20) presses the tapered face (5) downward.

The opposed member (16) has a plate-like shape, and has a circular through hole (16a) through which the tapered shank (3) is to be inserted. The through hole (16a) is dimensioned to have a space with respect to the outer peripheral tapered surface (3a) of the tapered shank (3). In addition, an upper end face of the opposed member (16) is formed such that there is a clearance with respect to a lower end face of the V-flange (2).

The opposed member (16) is provided at circumferentially appropriate intervals (for example, at equal intervals) thereof with a plurality of (three in this embodiment) pins (29) that are opposed to an outer peripheral surface of the V-flange (2) so as to protrude upward. The plurality of pins (29) are positioned so as to almost contact an outer periphery of the V-flange (2). This configuration allows the plurality of pins (29) to guide the V-flange (2) when the tool pot (11) moves vertically at the time when the tool is to be held, and thereafter, to prevent radial movement of the tool (1).

The guide (17) is inserted from an opening side at a lower end of the base member (12) and is fixed on the base member (12) with bolts, so as to close a lower end opening of the large-diameter part (13c) of the cylinder chamber (13).

The guide (17) has an upper face that is formed so as to receive the lower face of the lower small-diameter portion (26) of the intermediate part (15c) of the rod (15) when the rod (15) moves downward.

The connecting member (18) consists of a pair of plate-shaped members arranged so as to sandwich the base member (12). Each of the plate-shaped members has a lower end face that is fixed on the base member (12), and an upper end face that is fixed on the opposed member (16).

According to the above-described embodiment, the tool (1) is held by and dismounted from the tool pot (11) as follows.

In order to hold the tool (1) by the tool pot (11), firstly, the tool (1) is caused to move downward relative to the tool pot (11). FIG. 1 shows a state where the tool (1) is in the middle of the movement, in which an outer peripheral surface of the peripheral wall (14a) of the holder (14) is guided by the lower cylindrical face (4) of the inner peripheral surface (3c) of the tapered shank (3) of the tool (1), the plurality of pins (29) are apart from the V-flange (2) of the tool (1), and the key (21) is apart from the keyway (7), which is at an end surface of the tool (1). When the tool (1) is caused to move further downward relative to the tool pot (11) from the state shown in FIG. 1, the plurality of pins (29) make sliding contact with the outer periphery of the V flange (2), and the key (21) gets fitted into the keyway (7). Then, when the lower end surface (3b) of the tapered shank (3) is received by the upper surface of the flange part (14b) of the holder (14), movement of the tool pot (11) is stopped. With the configuration described above, because the plurality of pins (29) are opposed to the outer periphery of the V-flange (2), radial movement of the tool (1) is prevented, and because the key (21) is fitted into the keyway (7), rotation of the tool (1) is prevented. In this state, air has been introduced into the upper air-introduction compartment (27), whereby the rod (15) is positioned downward, and the plurality of steel balls (20) are positioned radially inward while being in contact with the tapered face (22) of the rod (15).

When the downward movement of the tool (1) is completed, air is discharged from the upper air-introduction compartment (27), and air is introduced into the lower air-introduction compartment (28). This causes the rod (15) to move upward relative to the holder (14).

At the time of the upward movement, the rod (15) is guided at the upper part (15a) thereof by the inner peripheral surface of the peripheral wall (14a) of the holder (14), is guided at the intermediate part (15c) thereof by the intermediate-diameter part (13b) of the cylinder chamber (13), and is guided at the lower part (15b) thereof by the guide (17). This upward movement of the rod (15) causes the plurality of steel balls (20), which are restricted by the radially through holes (19) and are capable of moving radially, to be pressed by the tapered face (22) of the rod (15) and to move radially outward in the radially through holes (19), thereby riding up on the tapered face (5) on an inner periphery of the tool (1). With the configuration described above, pressing of the tapered faces (5),(22) against each other with the plurality of steel balls (20) interposed therebetween causes the tool (1) to move downward. This causes the lower end surface (3b) of the tapered shank (3) to be strongly pressed against the upper surface of the flange part (14a) of the holder (14), whereby axial movement of the tool (1) is prevented, and rotation of the tool (1) is also prevented as a result of prevention of the rotation due to fitting of the key (21) and the keyway (7) with each other being reinforced. FIG. 2 shows this state, in which mounting of the tool (1) onto the tool pot (11) is completed.

In a case where the tool (1) is to be dismounted from the tool pot (11), air is discharged from the lower air-introduction compartment (28), and air is introduced into the upper air-introduction compartment (27). This causes the rod (15) to move downward. The plurality of steel balls (20) which have moved radially outward become capable of moving radially in the radially through holes (19) as a result of not receiving a force from the tapered face (22) of the rod (15), whereby the plurality of steel balls (20) move radially inward while being pressed by the tapered face (5) on the inner periphery of the tool (1). As a result, since the tool (1) becomes capable of moving upward, movement of the tool (1) upward to a position where the tool pot (11) does not interfere with the tool (1) allows the tool (1) to be dismounted from the tool pot (11).

FIG. 3 shows a state where vertical movement of the tool (1) relative to the tool pot (11) is impossible, which is indicated by solid lines, and shows a state where vertical movement of the tool (1) relative to the tool pot (11) is possible, which is indicated by alternate long and two short dashes lines. As seen from FIG. 3, the tool pot (11) of the present embodiment, in conclusion, has the greatest characteristic in that the tool pot (11) is capable of switching its states between: a state in which air is introduced into the lower air-introduction compartment (28) whereby the rod (15) moves upward, and pressing the tapered faces (5), (22) against each other with the plurality of steel balls (20) interposed therebetween causes vertical movement of the tool (1) relative to the tool pot (11) to be impossible; and a state in which air is introduced into the upper air-introduction compartment (27), whereby pressing the tapered faces (5), (22) against each other with the plurality of steel balls (20) interposed therebetween is cancelled, and vertical movement of the tool (1) relative to the tool pot (11) is possible.

The tool pot (11) of the above embodiment is different from the conventional tool pot that holds the outer peripheral surface (3a) of the tapered shank (3) and the end face of the V-flange (2) of the tool (1) in that the tool pot (11) of the above embodiment has the inner-periphery holding part (A) configured to hold the inner peripheral surface (3c) of the tapered shank (3), the end-face holding part (B) configured to hold an end face of the tool (1), and the outer-periphery holding part (C) configured to hold the outer periphery of the V flange (2).

The inner-periphery holding part (A) serves to hold the inner peripheral surface (3c) of the tapered shank (3) and prevent axial movement of the tool (1). The constituent elements of the inner-periphery holding part (A) are the holder (14), the plurality of steel balls (20), and the rod (pressing member) (15).

The end-face holding part (B) serves to hold the lower end surface (anti-V-flange-side end surface) (3b) of the tapered shank (3), which is the end face of the tool (1), and prevent rotation of the tool (1). The constituent element of the end-face holding part (B) is the key (21).

The outer-periphery holding part (C) is opposed to the outer periphery of the V-flange (2) and serves to prevent radial movement of the tool (1). The constituent element of the outer-periphery holding part (C) is the plurality of pins (29).

With the tool pot (11) of the above embodiment, the inner-periphery holding part (A) and the end-face holding part (B) described above are capable of holding the tool (1) in a state where there are clearances with respect to the outer peripheral surface (3a) of the tapered shank (3) and the end face of the V-flange (2), respectively, whereby the tool port (11) of the present embodiment is capable of overcoming the problem that dirt adhered to the tool pot is transferred to a contact face of a tool, which has been a problem of the conventional tool pot that has held the outer peripheral surface (3a) of the tapered shank (3) and the end face of the V-flange (2) of the tool (1).

### REFERENCE SIGNS LIST

(1): tool
(2): V-flange
(2a): V-groove
(3): tapered shank
(3a): outer peripheral surface (outer peripheral tapered surface)
(3b): lower end surface (anti-V-flange-side end surface)
(3c): inner peripheral surface
(5): tapered face
(7): keyway
(11): tool pot
(13): cylinder chamber
(14): holder
(14a): peripheral wall
(14b): flange part
(15): rod (pressing member)
(19): through hole
(20): steel ball
(21): key
(22): tapered face
(29): pin
(A): inner-periphery holding part
(B): end-face holding part
(C): outer-periphery holding part

1. A tool pot configured to hold a tool including a V-flange provided with a V-groove, and a tapered shank continued to the V-flange and having a hollow shape, the tool pot comprising:
an inner-periphery holding part configured to hold an inner periphery of the tapered shank and prevent axial movement of the tool;
an end-face holding part configured to prevent rotation of the tool, which is implemented by a key that is fitted into a keyway provided at an anti-V-flange-side end surface of the tapered shank; and
an outer-periphery holding part that is opposed to an outer periphery of the V-flange and is configured to prevent radial movement of the tool, wherein
the inner-periphery holding part, the end-face holding part, and the outer-periphery holding part hold the tool in a state where there are clearances with respect to an outer peripheral tapered surface of the tapered shank and an end face of the V-flange, respectively.

2. The tool pot according to claim 1, wherein
the inner-periphery holding part has: a holder having a cylindrical peripheral wall positioned radially inward of the tapered shank; a plurality of steel balls respectively disposed in a plurality of through holes in a radially movable manner, the through holes each being provided at a part, opposed to the tapered shank, of the peripheral wall of the holder; and a pressing member configured to press the plurality of steel balls radially outward, and
the plurality of steel balls pressed by the pressing member move radially outward to press a tapered face provided on the inner periphery of the tapered shank in an axial direction of the tool, and a flange part provided on the peripheral wall of the holder receives the end surface of the tapered shank, whereby axial movement of the tool is prevented.

3. The tool pot according to claim 2, wherein
the pressing member has a shaft shape and has a distal end portion provided at an outer periphery thereof with a tapered face, and is disposed in a cylinder chamber so as to move in an axial direction of the pressing member upon supply of compressed air, and
movement of the distal end portion of the pressing member in a distal end direction thereof causes the tapered face to move the plurality of steel balls radially outward.

4. The tool pot according to claim 1, wherein
the outer-periphery holding part is configured by a plurality of pins that are opposed to an outer peripheral surface of the V-flange.
